(19) United States
(12) Patent Application Publication
(10) Pub. No.: US 2026/0041104 A1
(43) Pub. Date: Feb. 12, 2026

(54) LAYERED PIZZA DOUGH PRODUCT AND METHOD OF COMMERCIAL MANUFACTURING

(71) Applicant: GENERAL MILLS, INC., Minneapolis, MN (US)

(72) Inventors: Christine O'Connor, Rogers, MN (US); Sorin Stingaciu, Richmond Hill (CA)

(73) Assignee: GENERAL MILLS, INC., Minneapolis, MN (US)

(21) Appl. No.: 19/292,135

(22) Filed: Aug. 6, 2025

Related U.S. Application Data
(60) Provisional application No. 63/679,864, filed on Aug. 6, 2024.

(51) Int. Cl. A21D 8/02; A21C 1/14; A21C 3/02; A21C 3/04; A21C 11/00; A21C 11/10; A21D 10/02

(52) U.S. Cl. CPC A21D 8/02; A21C 1/1425; A21C 3/022; A21C 3/04; A21C 11/006; A21C 11/10; A21D 10/02

(57) ABSTRACT

A method of manufacturing a layered pizza dough product with great extensibility includes forming a fresh high gluten dough, mixing the fresh high gluten dough with a rework dough to form a combination dough, sheeting the combination dough to form a sheeted dough, and lapping the sheeted dough to form a layered pizza dough. A system for manufacturing includes fresh and rework dough dispensers, a controller, a mixer for combining the fresh and rework doughs, an extruder and a lapper. A layered pizza dough product with great extensibility comprises eight to thirty layers of a high gluten pizza dough, wherein the high gluten pizza dough comprises up to about 40% rework dough by weight.

### CROSS-REFERENCE TO RELATED APPLICATIONS

This application claims priority to U.S. Provisional Application No. 63/679,864, filed Aug. 6, 2024, the entire contents of which are incorporated herein by reference.

### TECHNICAL FIELD

The disclosure generally pertains to food products and, more particularly, to pizza dough products that have high extensibility. The disclosure further relates to methods and systems of manufacturing pizza dough products having high extensibility.

### BACKGROUND

High gluten pizza dough helps create the artisan-style eating experience consumers want in their pizza. However, it is difficult for restaurant operators to handle conventional high gluten pizza dough due to dough “snapback”, i.e., lack of extensibility or high shape memory. As a function of the high gluten content, conventional high gluten pizza dough either does not stretch to the size and shape needed or shrinks back once it is stretched to the desired size or shape. Due at least to these issues, high gluten pizza doughs are not employed at most pizza making establishments.

### SUMMARY

A method of manufacturing a layered pizza dough product of the present disclosure comprises forming a fresh high gluten dough, mixing the fresh high gluten dough with a rework dough to form a combination dough wherein the rework dough forms up to about 40% of the combination dough, sheeting the combination dough to form a sheeted dough, and lapping the sheeted dough to form a layered pizza dough. In some embodiments, lapping the sheeting dough to form a layered pizza dough comprises forming at least four layers of the sheeted dough. The layered pizza dough is cut into one or more shapes (e.g., circular, disc shapes) which can be sized depending on the desired final product. Cutting one or more shapes from the layered pizza dough results in trim/scrap dough (e.g., a webbing of trim dough) which is separated from the cut shapes of dough and transported away to be re-used as rework dough at the beginning of the process.

A system for manufacturing a layered pizza dough product according to the present disclosure comprises: a first dough dispenser for dispensing a fresh high gluten dough, a second dough dispenser for dispensing a rework dough, a controller for controlling the first and second dough dispensers, a mixer for combining the dispensed fresh high gluten dough and the dispensed rework dough to form a combination dough, an extruder for sheeting the combination dough to form a sheeted dough, and a lapper for lapping the sheeted dough to form a layered pizza dough. In some embodiments, the dough dispensers are dough chunkers. The controller controls the dispensing of the fresh high gluten dough and the rework dough from the dispensers. In particular, the controller is configured to control the ratio of fresh high gluten dough dispensed to rework dough dispensed. In some embodiments, the lapper is configured to form a layered pizza dough having at least four layers. In preferred embodiments, the cutter is a rotary cutter having one or more cutting molds mounted upon a rotating shaft.

In preferred embodiments, the manufacturing method forms, or the manufacturing system is configured to form, a continuous sheet of dough that is fed through the various system components.

A particularly preferred layered pizza dough product in accordance with the present disclosure comprises eight to thirty layers of a high gluten pizza dough, wherein the high gluten pizza dough comprises up to about 40%, including about 30% to about 40% rework dough by weight. In preferred embodiments, the high gluten pizza dough comprises a flour having about 14.2% protein. In some embodiments, the rework dough comprises eight to thirty-two sub-layers. In certain embodiments, the product shaped to take the form of a disc. In accordance with the disclosure, the pizza dough product has a snapback score less than 2.0 and/or a deformability score greater than 12.0.

### BRIEF DESCRIPTION OF THE DRAWINGS

FIG. 1 is an overview of a process and system for producing a high-gluten layered pizza dough product in accordance with certain embodiments of the present disclosure.

FIG. 2 is a depiction of a portion of a production line in accordance with certain embodiments of the present disclosure in which dough shapes are separated from a dough sheet, creating trim/scrap dough.

FIG. 3 is a depiction of a layered pizza dough product produced in accordance with the present disclosure.

### DETAILED DESCRIPTION

Initially, it should be noted that the embodiments of the present disclosure described below are not intended to be exhaustive or limit the disclosure to the precise forms disclosed in the following detailed description. Rather, a purpose of the embodiments chosen and described is so that the appreciation and understanding by others skilled in the art of the principles and practices of the present disclosure can be facilitated.

Throughout the present description, unless otherwise specified, the concentrations expressed as percentages always refer to the weight/weight (w/w) percentage, i.e., grams of a given component per 100 g of composition, i.e., wt % or percent by weight. The term “about” refers to a deviation of up to plus/minus 10%, preferably plus/minus 5%.

Typically, pizza dough manufacturing processes use divider/rounder technology to portion pizza dough into dough balls. The dough balls are frozen and sent to restaurant operators. These conventional high gluten pizza dough balls can be stretched to form a pizza crust but can exhibit significant snapback. As used herein, the terms “high gluten” or “high gluten content” refer to a dough made using a high protein flour (i.e., a flour having about 12% protein or more, e.g., about 12.8% protein, about 13.2% protein or about 14.2% protein). The term “snapback” refers to a dough's shape memory or lack of extensibility. See the Example section below for more details. The present inventors have discovered an alternative approach for producing portioned pizza dough having high gluten content but advantageously having a significant reduction in snapback. In particular, the inventors have discovered that sheeting a high gluten pizza dough, with the dough comprising up to about 40% rework (trim) dough mixed with fresh dough, and then lapping the sheeted dough multiple times creates a layered dough with significantly greater extensibility. As used herein, the terms “rework” or “trim” refer to dough leftover once the sheeted and lapped (layered) dough is cut to shape. For example, a plurality of disc shapes is cut into a layered dough sheet and the dough webbing remaining between the disc shapes is the rework or trim dough. Provided that the rework dough is the dough leftover once the sheeted and lapped dough is cut to shape, the initial runs of sheeted and lapped dough that is cut to shape may not have any rework dough incorporated therein. As the rework dough is continuously mixed with the fresh dough, the combination dough will incorporate more rework dough into the formulation over time to an amount up to about 40% rework dough, including between about 30% to about 40% rework dough. The sheeted and lapped dough can be formed into a disc shaped product that can be easily handled by restaurant operators, easily spread out onto pans of different sizes as needed by back-of-house operators. Without being bound by theory, it is believed the combination of sheeting, lapping and use of rework dough created employing the aspects of the disclosure causes the gluten in the high gluten dough to relax sufficiently to allow users to easily stretch and form the layered dough product.

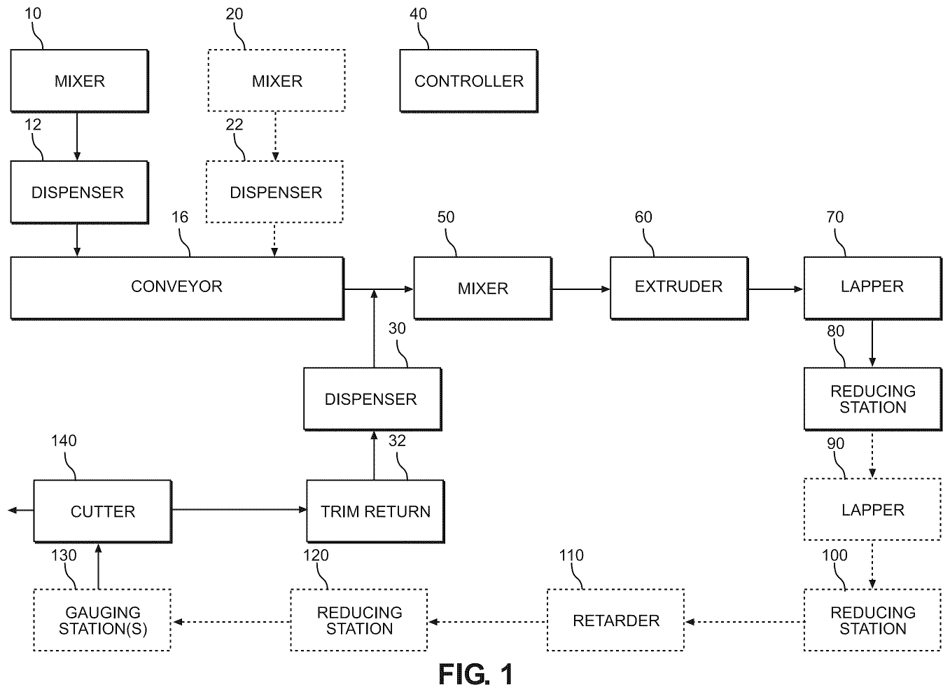

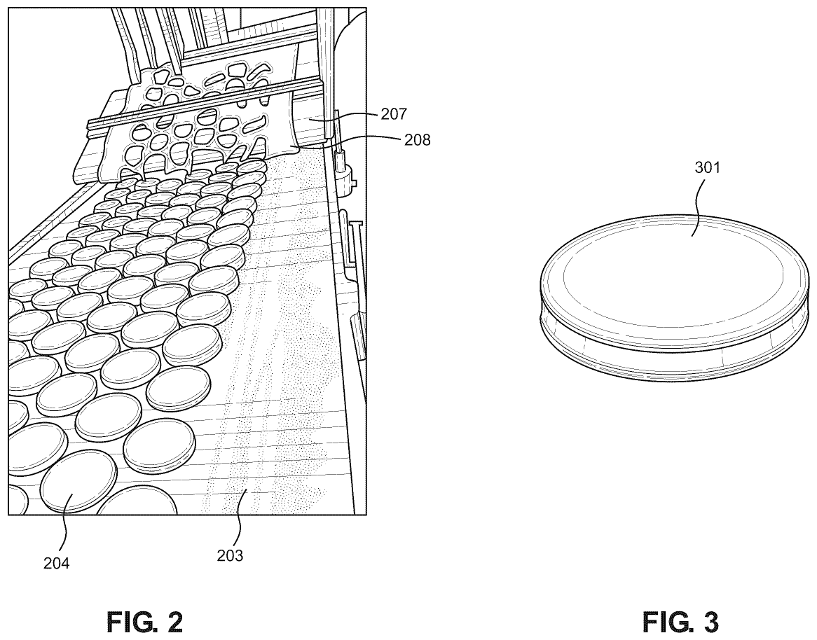

A method of manufacturing a layered pizza dough product of the present disclosure comprises forming a fresh high gluten dough, mixing the fresh high gluten dough with a rework dough created using the layering technique provided herein to form a combination dough, wherein the rework dough forms up to about 40% of the combination dough, sheeting the combination dough to form a sheeted dough, and lapping the sheeted dough to form a layered pizza dough. In some aspects, the combination dough comprises about 5% to about 40%, about 10% to about 40%, about 20% to about 40%, or about 30% to about 40% of rework dough. Reference is made to FIGS. 1 and 2 in describing an exemplary process employed to manufacture a layered pizza dough product, with this exemplary arrangement being presented for purposes of fully understanding the disclosure.

With reference to the figures, fresh high gluten dough is formed in a first mixer 10 (e.g., a horizontal bar mixer). In some embodiments, forming a fresh high gluten dough comprises mixing dough ingredients including high protein flour, sugar, yeast, fat and water. In preferred embodiments, the fresh high gluten dough is a high quality, artisan level dough formed using a flour having about 14.2% protein. In the exemplary arrangement shown, the formed fresh high gluten dough is dispensed via a dispenser 12 upon a conveyor 16. In some embodiments, the high gluten dough is dispensed in the form of chunks (i.e., dispenser 12 is a dough chunker which feeds chunks of fresh high gluten dough from mixer 10 to conveyor 16). Additional fresh high gluten dough can be formed and dispensed from one or more additional mixers 20 and dispensers 22.

Rework dough is dispensed via a dispenser 30 sourced by a trim return 32, which is detailed further below. In some embodiments, rework dough is dispensed in the form of chunks (i.e., dispenser 30 is a dough chunker which feeds chunks of the rework dough from trim return 32). The dispensing of the fresh high gluten dough and the rework dough from dispensers 12 and 30, respectively, (and optionally, one or more additional dispensers 22) is controlled by a controller 40. Controller 40 is configured to control the ratio of fresh high gluten dough dispensed to rework dough dispensed (e.g., via use of the one or more the photoeyes discussed below in reference to the system of the present disclosure). In some embodiments, the ratio of fresh high gluten dough dispensed to rework dough dispensed is 2:1 (e.g., two chunks of fresh high gluten dough to one chunk of rework dough).

Dispensed rework dough is combined with dispensed fresh high gluten dough in a mixer 50 to form a combination dough. The rework dough may form up to about 40% of the combination dough. As described herein, in some aspects, the rework dough may form about 5% to about 40%, about 10% to about 40%, about 20% to about 40%, or about 30% to about 40% of the combination dough.

The combination dough is fed to and sheeted by an extruder 60 (e.g., a five-roll extruder) to form a sheeted dough. The sheeted dough is then fed to a first lapper 70 to form a layered pizza dough. In some embodiments, lapping the sheeting dough to form a layered pizza dough comprises forming at least four layers of the sheeted dough. The layered pizza dough is compressed in a reducing station 80 (e.g., including a multi-roller or quick reducer) so as to reduce its height and prevent delamination. In some embodiments, the process includes one or more further sets of lapping and compressing steps (e.g., via an additional lapper 90 and an additional reducing station 100). In some embodiments, the dough is lapped to form a layered pizza dough having from eight to thirty cumulative layers.

In some embodiments, after the lapping and compressing steps, the compressed layered pizza dough is sent to a retarder 110, a further reducing station 120 and one or more gauging stations 130 before being cut at a cutter 140. In the retarder 110, the dough is cooled and allowed to relax and the gluten in the dough develops. In some embodiments, the dough is in the retarder for about 20 minutes. In the one or more gauging stations 130, the edges of the dough sheet are pushed in from the sides.

The layered pizza dough is cut into one or more shapes (e.g., circular, disc shapes) at cutter 140. The cut shapes can be sized depending on the desired final product. For example, cutting discs of dough having a diameter of 4, 5 or 6 inches can yield an 8, 16 or 20 ounce pizza dough product, respectively. Cutting one or more shapes from the layered pizza dough results in trim/scrap dough (e.g., a webbing of trim dough). The manufacturing method of the present disclosure is intended to be zero waste or near zero waste in that all or nearly all of the trim/scrap dough is separated from the cut shapes of dough and transported away from cutter 140 using trim return 32 to be re-used as rework dough (specifically layered reworked dough) at the beginning of the process. Sec, e.g., the arrangement shown in FIG. 2. In some embodiments, a conveyor 203 conveys the cut dough shapes 204 (shown as disc shapes) away while another conveyor 207, which is part of trim return 32, transports the trim/scrap dough 208 (shown as webbing) to dispenser 30 to be dispensed as rework dough. In some embodiments, the webbed trim/scrap dough 208 is divided using one or more cutters (e.g., one or more guillotine cutters) that are part of trim return 32 before trim/scrap dough 208 reaches dispenser 30.

In preferred embodiments, the manufacturing method forms a continuous sheet of dough that is fed through the various system components.

A system for commercial manufacturing a layered pizza dough product according to the present disclosure comprises: a first dough dispenser for dispensing a fresh high gluten dough, a second dough dispenser for dispensing a rework dough, a controller for controlling the first and second dough dispensers, a mixer for combining the dispensed fresh high gluten dough and the dispensed rework dough to form a combination dough, an extruder for sheeting the combination dough to form a sheeted dough and at least one lapper for lapping the sheeted dough to form a layered pizza dough. Reference is made to FIGS. 1 and 2 in describing an exemplary arrangement employed to manufacture a layered pizza dough product, with this exemplary arrangement being presented for purposes of fully understanding the disclosure.

As shown, the arrangement of FIG. 1 includes a first dispenser 12 for dispensing fresh high gluten dough. In some embodiments, dispenser 12 is a dough chunker which feeds chunks of the fresh high gluten dough from mixer 10 to conveyor 16. The system can further include one or more additional fresh high gluten dough mixers 20 and dispensers 22. In some embodiments, one or more photoeyes (not shown) are attached to mixers 10 and/or 20 looking into dispensers 12 and/or 22, respectively, to determine if the dispensers are emptied.

A second dispenser 30 dispenses rework dough sourced by a trim return 32, which is detailed further below. In some embodiments, dispenser 30 is a dough chunker which feeds chunks of the rework dough from trim return 32.

In some embodiments, one or more photoeyes (not shown) are positioned between fresh dough dispenser 12 and rework dough dispenser 30 for monitoring transit of fresh dough. Controller 40 controls the dispensing of the fresh high gluten dough and the rework dough from dispensers 12 and 30, respectively (and optionally, one or more dispensers 22). Controller 40 is configured to control the ratio of fresh high gluten dough dispensed to rework dough dispensed (e.g., via use of the one or more photoeyes mentioned above). In some embodiments, controller 40 can be configured to control the ratio of fresh high gluten dough dispensed to rework dough dispensed to be 2:1 (e.g., two chunks of fresh high gluten dough to one chunk of rework dough). Controller 40 can be configured to pause the dispensing of the fresh dough if trim return 32/dispenser 30 is paused. Controller 40 can also be configured to pause dispenser 30 if a chunk of fresh dough is passing underneath (so a chunk of rework dough does not land on a chunk of fresh dough) or direct dispenser 30 to proceed. Mixer 50 combines dispensed rework dough with dispensed fresh high gluten dough to form a combination dough. The rework dough forms up to about 40% of the combination dough.

Extruder 60 (e.g., a five-roll extruder) sheets the combination dough to form a sheeted dough and a first lapper 70 laps the sheeted dough to form a layered pizza dough. In some embodiments, first lapper 70 is configured to form a layered pizza dough having at least four layers. Reducing station 80 (e.g., including a multi-roller or quick reducer) compresses the layered pizza dough so as to reduce its height and prevent delamination. In some embodiments, the system includes one or more further pairs of a lapper and a reducing station (e.g., additional lapper 90 and additional reducing station 100).

In some embodiments, the system further includes a retarder 110, a further reducing station 120 and one or more gauging stations 130. In the retarder 110, the dough is cooled and allowed to relax, and the gluten in the dough develops. In some embodiments, the dough is in the retarder for about 20 minutes. In the one or more gauging stations 130, the edges of the dough sheet are pushed in from the sides.

Cutter 140 cuts the layered pizza dough into one or more shapes (e.g., circular, disc shapes). In preferred embodiments, cutter 140 is a rotary cutter having one or more cutting molds mounted upon a rotating shaft. The cutting molds can be sized depending on the desired final product. For example, cutting molds having a diameter of 4, 5 or 6 inches can yield an 8, 16 or 20 ounce pizza dough product, respectively. Cutting one or more shapes from the layered pizza dough results in trim/scrap dough (e.g., a webbing of trim dough). The system of the present disclosure is configured to be zero waste or near zero waste in that all or nearly all of the trim/scrap dough is separated from the cut shapes of dough and transported away from cutter 140 using trim return 32 to be re-used as rework dough. See, e.g., the arrangement shown in FIG. 2. In some embodiments, a conveyor 203 conveys the cut dough shapes 204 (shown as disc shapes) away while another conveyor 207 as part of trim return 32 transports the trim/scrap dough 208 (shown as webbing) to dispenser 30 to be dispensed as rework dough. In some embodiments, trim return 32 further includes one or more cutters (e.g., one or more guillotine cutters) for dividing the webbed trim/scrap dough 208 before it reaches dispenser 30.

In preferred embodiments, the system is configured to form a continuous sheet of dough that is fed through the various system components.

A layered pizza dough product in accordance with the present disclosure comprises eight to thirty layers of a high gluten pizza dough, wherein the high gluten pizza dough comprises up to about 40% rework dough by weight. In preferred embodiments, the high gluten pizza dough comprises a flour having about 14.2% protein. In some embodiments, the rework dough comprises eight to thirty sub-layers. As detailed above in relation to the method and system of the present disclosure, rework dough is trim/scrap dough cut from a layered dough product having, e.g., eight to thirty, or more, cumulative layers. In this example, the rework dough therefore includes eight to thirty layers which are considered sub-layers in relation to the layers subsequently formed when the rework dough is incorporated into the combination dough and sheeted and lapped into the layered pizza dough which is cut to form the inventive layered pizza dough product.

In preferred embodiments, the product is in the shape of a disc. See, for example, disc-shaped product 301 in FIG. 3. In contrast, many conventional pizza dough products are provided in ball form. Without being bound by theory, it is believed the disc shape of the preferred embodiments of the present disclosure is easier for a user to stretch to the desired shape and size of a pizza crust compared to dough balls.

In preferred embodiments, the pizza dough product of the present disclosure has a snapback score less than 2.0 and/or a deformability score greater than 12.0. See the Example section below for details regarding snapback and deformability scores. In some embodiments, the product is able to be stretched to size (e.g., 14 inches in diameter) directly out of the refrigerator, without floor rest, but can also perform for 90 or more minutes at room temperature (e.g., about 75-80 degrees Fahrenheit).

### EXAMPLE

A layered pizza dough product of the present disclosure was tested against two conventional pizza dough products both made with a divider rounder and without lapping (i.e., prior art product A and prior art product B). Each sample tested weighed about 454 grams and was tested for snapback, stretchability and deformability (degree to which the sample returns to, remains in its shape after pressure or stretch). Snapback and deformability were evaluated on a scale of 0.0 to 15.0. For snapback, a score of 0.0 indicated no snapback (i.e., no shrinking back after stretching), while a score of 15.0 indicated high snapback. Table 1 below illustrates the standards developed to evaluate snapback on this scale of 0.0 to 15.0. For deformability, a score of 0.0 indicated the sample did not retain its shape after being picked up and moved around, while a score of 15.0 indicated the sample remained in its shape after being picked up and moved around. For stretchability, the dough sample was stretched into a circular shape on a pastry mat having diameter measurement markings.

Table 2 below shows the results of the sample testing. The inventive product showed meaningful differences in snapback, stretchability and deformability against both conventional products (e.g., differences greater than or equal to 0.5 on the 15.0 point scale). Notably, the inventive product stretched to size (14 inches) and beyond quicker than Prior Art Product A and formed no holes even when stretched beyond 20 inches. The prior art products exhibited windowing and holes when stretched to 16 inches. Prior Art Product A snapped back by up to 1 inch within 60 seconds after stretching while the inventive product showed minimal snapback within 60 seconds (approximately ¼ inch).

TABLE 1

| Score | Product | Preparation |
|---|---|---|
| 0.0 | Pillsbury Chub Sugar Cookie | Unwrap and slice into ½ |
| | (Refrigerated) | inch slices |
| 3.0 | Pillsbury Pizza Crust (Pouch) | Make according to |
| | | instructions |
| 5.0 | Pillsbury Pizza Crust (Thin | Cut into 6 pieces with |
| | Crust, Refrigerated) | pizza cutter |
| 15.0 | Albanese Gummy Worms | 3 Gummy Worms |
| | (Candy) | (Room temperature) |

TABLE 2

| | Product of the | Prior Art | Prior Art |
|---|---|---|---|
| Attribute | Disclosure | Product A | Product B |
| Snapback | 1.6 | 3.4 | 3.8 |
| Deformability | 12.8 | 8.1 | 10.4 |
| Stretchability | 18.0 inches | 16.1 inches | 16.6 inches |

1. A method of manufacturing a layered pizza dough product, the method comprising:
a. forming a fresh high gluten dough;
b. mixing the fresh high gluten dough with a rework dough to form a combination dough, wherein the rework dough forms up to about 40% of the combination dough;
c. sheeting the combination dough to form a sheeted dough; and
d. lapping the sheeted dough to form a layered pizza dough.

2. The method of claim 1, further comprising:
e. compressing the layered pizza dough.

3. The method of claim 2, further comprising:
f. cutting the compressed layered pizza dough to form the layered pizza dough product and the rework dough.

4. The method of claim 2, further comprising:
f. lapping the compressed layered pizza dough.

5. The method of claim 1, wherein forming the fresh high gluten dough comprises mixing dough ingredients including high protein flour, sugar, yeast, fat and water.

6. The method of claim 1, wherein lapping the sheeted dough to form a layered pizza dough comprises forming at least four layers of the sheeted dough.

7. The method of claim 1, wherein the rework dough forms about 30% to about 40% of the combination dough.

8. A system for manufacturing a layered pizza dough product, the system comprising
a. a first dough dispenser for dispensing a fresh high gluten dough;
b. a second dough dispenser for dispensing a rework dough;
c. a controller for controlling the first and second dough dispensers, the controller being configured to control the ratio of fresh high gluten dough dispensed to rework dough dispensed;
d. a mixer for combining the dispensed fresh high gluten dough and the dispensed rework dough to form a combination dough;
e. an extruder for sheeting the combination dough to form a sheeted dough; and
f. a lapper for lapping the sheeted dough to form a layered pizza dough.

9. The system of claim 8, further comprising:
g. a reducing station for compressing the layered pizza dough.

10. The system of claim 9, further comprising:
h. a cutter for cutting the compressed layered pizza dough to form the layered pizza dough product and the rework dough.

11. The system of claim 10, further comprising:
i. a trim return for directing the rework dough to the second dough dispenser.

12. The system of claim 9, further comprising:
h. an additional lapper for lapping the compressed layered pizza dough.

13. The system of claim 8, wherein the lapper is configured to form a layered pizza dough having from four to thirty layers.

14. A layered pizza dough product, the product comprising eight to thirty layers of a high gluten pizza dough, wherein the high gluten pizza dough comprises up to about 40% rework dough by weight.

15. The product of claim 14, wherein the rework dough comprises eight to thirty sub-layers.

16. The product of claim 14, wherein the product is in the shape of a disc.

17. The product of claim 14, wherein the product has a snapback score less than 2.0, a deformability score greater than 12.0, or a combination thereof.

18. The product of claim 14, wherein the high gluten pizza dough comprises about 30% to about 40% rework dough by weight.

19. The product of claim 14, wherein the high gluten pizza dough comprises a flour having about 14.2% protein.

20. The product of claim 14, wherein the high gluten pizza dough comprises high protein flour, sugar, yeast, fat and water.
